(19) United States
(12) Patent Application Publication
(10) Pub. No.: US 2008/0277246 A1
(43) Pub. Date: Nov. 13, 2008

(54) Reciprocating slat conveyer

(75) Inventor: Timothy Berthelsen, Tillamook, OR (US)

Correspondence Address: KLARQUIST SPARKMAN, LLP, 121 SW SALMON STREET, SUITE 1600, PORTLAND, OR, 97204, US

(73) Assignee: Hallco Manufacturing Co., Inc.

(21) Appl. No.: 12/151,625

(22) Filed: May 7, 2008

Related U.S. Application Data
(60) Provisional application No. 60/928,196, filed on May 7, 2007.

(51) Int. Cl. B65G 25/04

(52) U.S. Cl. 198/750.5; 198/750.2

(57) ABSTRACT

The present disclosure concerns embodiments of a reciprocating slat conveyor, such as used to form the floor of a mobile cargo container. For example, the slat conveyor can be installed in the collection area of a garbage collection truck. In particular embodiments, the conveyor includes an elongated floor assembly that has a concave upper surface such that the left and right longitudinal sides of the floor assembly curve upwardly from the longitudinal center of the floor assembly. In this manner, materials, especially liquids, tend to funnel downwardly along the curved portions of the floor assembly and accumulate proximate the center of the floor assembly.

### CROSS REFERENCE TO RELATED APPLICATION

The present application claims the benefit of U.S. Provisional Application No. 60/928,196, filed May 7, 2007, which is incorporated herein by reference.

### FIELD

The present application concerns embodiments of a reciprocating slat conveyor.

### BACKGROUND

Reciprocating conveyor systems for conveying particulate materials are known in the art. For example, it is known to use reciprocating conveyor systems to form the floor of a mobile cargo container, such as a semi-trailer or the collection area of a garbage collection truck.

Known conveyor systems typically include a plurality of elongated reciprocating slats that systematically move relative to the container floor and to each other to convey particulate materials housed within the container. The materials are conveyed in a rearwardly direction and are expelled from the container at a rear portion of the container. In certain prior art conveyor systems, seals are positioned between adjacent slats to minimize the loss of particulate materials through the space between the slats. In some prior art conveyor systems that do not include such seals between the slats, particulate materials that fall between the slats are managed by clearing it away during the conveying process and/or routine maintenance, which can result in a loss of these materials. To prevent loss of particulate materials, some conventional seal-less conveyor systems include a false floor below the moving slat members to prevent the materials from falling to the ground. Materials accumulating on the false floor, however, often negatively affect the performance of the conveyor system.

The relative movement of slats in a conveyor system is typically facilitated by a drive mechanism. In some prior art systems that include a false floor, the drive mechanism is placed below the false floor. To provide such an arrangement, large holes in the false floor are required for coupling the drive mechanism to the slats. Particulate materials that accumulate on the false floor, however, have a tendency to fall through this hole and undesirably filter to the ground. To avoid this problem, in some known reciprocating conveyor systems, the entire drive mechanism or portions of the drive mechanism are placed above the floor and within the cargo area. This arrangement, however, displaces valuable space which could otherwise be used for storing particulate materials.

To overcome this problem, some prior art systems place the hydraulic portion of the drive mechanism forward of the cargo area and position the cross-drive members of the drive mechanism in front of and in alignment with the reciprocating slats. This arrangement can conserve cargo space, but introduces other disadvantages. For example, the piston rods of the hydraulic portion of the drive mechanism are coupled to the slats via a cross-drive connector, cross-drives and elongated fingers extending from the cross-drives to the slats. The connection between the piston rods and the cross-drive connector is a ball and socket joint such that the cross-drive connector, cross-drives, elongated fingers and the plurality of slats are pivotable relative to the piston rods. Because the piston rods are not maintained in alignment with the slats, the slats tend to laterally buckle and become misaligned with the piston rods. Such lateral misalignment often causes the slats to engage the sides of the container, which can restrict movement of the slats. Further, lateral misalignment can cause side wear and eventually failure of the piston rods and associated piston rod seals.

Some conventional mobile cargo containers, such as a refuse containment area of certain garbage collection trucks, have a generally arcuate or curved floor. The floors are typically elongated in a longitudinal direction such that the floor defines a generally concave support surface arcing about a central axis that extends parallel to the longitudinal direction. The arcuate nature of the floor provides several advantages, such as, for example, additional cargo space, reduced weight, and a collection area for liquids and lateral containment of the refuse. In some mobile cargo containers having an arcuate floor, the floor has a radius of curvature between approximately 150 and 250 inches. In more specific instances, the arcuate floor of a mobile cargo container can have a radius of curvature of approximately 205 inches.

Conventional reciprocating conveyor systems are designed for cargo containers having flat floors and configured to have a flat material support surface. Accordingly, such conventional systems would not be compatible with mobile cargo containers having arcuate floors. For example, if a conventional reciprocating conveyor were used in a container with an arcuate floor, the material support surface would remain flat such that the advantages of having an arcuate floor would be obviated. Accordingly, it would be desirable to provide a reciprocating conveyor system that is adapted to operate within a mobile cargo container with an arcuate floor and maintain the advantages that an arcuate floor provides.

### SUMMARY

The present disclosure concerns embodiments of a reciprocating slat conveyor, such as used to form the floor of a mobile cargo container. For example, the slat conveyor can be installed in the collection area of a garbage collection truck. In particular embodiments, the conveyor includes an elongated floor assembly that has a concave upper surface such that the left and right longitudinal sides of the floor assembly curve upwardly from the longitudinal center of the floor assembly. In this manner, materials, especially liquids, tend to funnel downwardly along the curved portions of the floor assembly and accumulate proximate the center of the floor assembly. The floor assembly is especially adapted for use with cargo containers having a concave bottom floor although it can be installed in cargo containers having a flat floor if desired.

The floor assembly can comprise a plurality of elongated, load-supporting slats that are operable to reciprocate longitudinally of the floor assembly. The conveyor also includes a drive mechanism that is configured to effect reciprocating movement of the slats. The slats desirably are arranged as multiple sets of slats, such as three sets of slats, that are configured to reciprocate relative to each other. The conveyor can include a plurality of cross-drive assemblies, each of which couples a reciprocating piston rod of the drive mechanism to a corresponding set of slats. In this manner, reciprocating movement of a piston rod is effective to cause corresponding movement of a cross-drive assembly and a set of slats. The piston rods can be operated to reciprocate the slats in a predetermined sequence to convey material along the upper surface of the floor assembly.

In particular embodiments, the piston rods are fixedly coupled to respective cross-drive assemblies. In particular, each piston rod can be fixedly secured to the forward end portion of a respective push rod that is longitudinally aligned with and extends parallel to the piston rod. The rear end portion of each push rod can be fixedly secured to a curved support plate of a respective cross-drive assembly. In certain embodiments, the conveyor includes three piston rods, three corresponding push rods, three corresponding cross-drive assemblies, and three sets of slats carried by respective cross-drive assemblies. The curved support plates of the cross-drive assemblies desirably are positioned side-by-side along the length of the floor assembly and at the same level in the floor assembly to minimize the overall cross-sectional profile (thickness) of the floor assembly.

In one representative embodiment, a reciprocating slat conveyor comprises a floor assembly defining an upper surface and a bottom surface. The floor assembly comprises a plurality of elongated, load-supporting slats operable to reciprocate longitudinally of the floor assembly. The upper surface of the floor assembly comprises a concave surface that is curved about an axis located above and extending longitudinally of the floor assembly.

In another representative embodiment, a container assembly for a vehicle comprises a container for containing a load. The container has a forward end, a rear end defining a container opening, and a floor. The assembly further comprises a conveyor supported on the floor of the container. The conveyor comprises a floor assembly defining an upper surface, a bottom surface, a forward end, and a rear end proximate the container opening. The floor assembly also comprises a plurality of elongated, load-supporting slats operable to reciprocate longitudinally of the floor assembly. The upper surface of the floor assembly can comprise a concave surface that is curved about an axis located above and extending longitudinally of the floor assembly.

In another representative embodiment, a reciprocating slat conveyor comprises a drive mechanism comprising at least first and second reciprocating piston rods, at least first and second cross-drives, at least first and second connector arms having respective forward end portions coupled to the first and second piston rods, respectively, the first and second connector arms also having respective rear end portions connected to the first and second cross-drives, respectively. The conveyor also comprises a floor assembly defining an upper surface, a bottom surface and a height between the upper surface and the bottom surface. The floor assembly comprises a plurality of elongated, load-supporting slats operable to reciprocate longitudinally of the floor assembly. The plurality of slats comprises a first set of slats connected to the first cross-drive and a second set of slats connected to the second cross-drive such that reciprocating movement of the first piston rod causes corresponding movement of the first connector arm, the first cross-drive and the first set of slats, and reciprocating movement of the second piston rod causes corresponding movement of the second connector arm, the second cross-drive and the second set of slats. Additionally, the rear end portions of the connector arms desirably extend into the floor assembly at or below the upper surface and at or above the lower surface to minimize the height of the floor assembly.

In another representative embodiment, a reciprocating slat conveyor comprises a floor assembly comprising a first, forward set of longitudinally extending guide beams and a second, rear set of longitudinally extending guide beams that are longitudinally spaced from the first set of the guide beams by a cross-drive reciprocating zone. The floor assembly also comprises at least first and second cross-drives disposed in the reciprocating zone between the first and second set of guide beams, and a plurality of elongated, load-supporting slats operable to reciprocate longitudinally of the floor assembly. The plurality of slats comprises at least a first and second set of slats, each slat of the first set of slats being supported on respective guide beams of the first and second sets of guide beams and being connected to the first cross-drive, and each slat of the second set of slats being supported on respective guide beams of the first and second sets of guide beams and being connected to the second cross-drive. Hence, reciprocating movement of the first cross-drive causes corresponding movement of the first set of slats and reciprocating moving of the second cross-drive causes corresponding movement of the second set of slats.

In yet another representative embodiment, a container assembly for a vehicle comprises a container for containing a load, the container having a forward end and a rear end defining a container opening, the container having a liquid-impermeable floor. The assembly further comprises a conveyor supported on the floor of the container, the conveyor comprising a floor assembly defining a forward end and a rear end proximate the container opening. The floor assembly comprises at least first and second cross-drives and a plurality of elongated, load-supporting slats operable to reciprocate longitudinally of the floor assembly. The plurality of slats comprises a first set of slats connected to the first cross-drive at a position above the first cross-drive and a second set of slats connected to the second cross-drive at a position above the second cross-drive. Reciprocating movement of the first cross-drive causes corresponding movement of the first set of slats and reciprocating moving of the second cross-drive causes corresponding movement of the second set of slats.

### BRIEF DESCRIPTION OF THE DRAWINGS

FIG. 1 is a top perspective view of a reciprocating slat conveyor according to one exemplary embodiment.

FIG. 2 is a front elevation view of the reciprocating slat conveyor of FIG. 1.

FIG. 3 is a rear elevation view of the reciprocating slat conveyor of FIG. 1.

FIG. 4 is a rear perspective view of a reciprocating slat conveyor installed in a garbage containment area of a garbage collection truck.

FIG. 5 is an enlarged rear elevation view of a section of the reciprocating slat conveyor of FIG. 1.

FIG. 6 is an enlarged front bottom perspective view of a section of the reciprocating slat conveyor of FIG. 1.

FIG. 7 is an enlarged rear bottom perspective view of a section of the reciprocating slat conveyor of FIG. 1.

FIG. 8 is a bottom perspective view of the reciprocating slat conveyor of FIG. 1.

FIG. 9 is an enlarged top perspective view of the drive mechanism and a section of the reciprocating slat conveyor of FIG. 1.

FIG. 10 is an enlarged top perspective view of the drive mechanism of the reciprocating slat conveyor of FIG. 1 shown without the floor assembly.

FIG. 11 is an enlarged front bottom perspective view of the drive mechanism and a section of the reciprocating slat conveyor of FIG. 1.

FIG. 12 is en enlarged front bottom view of the drive mechanism of the reciprocating slat conveyor of FIG. 1 showing a single drive assembly.

FIGS. 13-17 show a slat reciprocation sequence of a reciprocating slat conveyor according to one embodiment.

FIG. 18 is a schematic of a hydraulic circuit that can be used to operate the slat conveyor of FIG. 1, according to one embodiment.

### DETAILED DESCRIPTION

As used herein, the singular forms “a,” “an,” and “the” refer to one or more than one, unless the context clearly dictates otherwise.

As used herein, the term “includes” means “comprises.” For example, a device that includes or comprises A and B contains A and B but may optionally contain C or other components other than A and B. A device that includes or comprises A or B may contain A or B or A and B, and optionally one or more other components such as C.

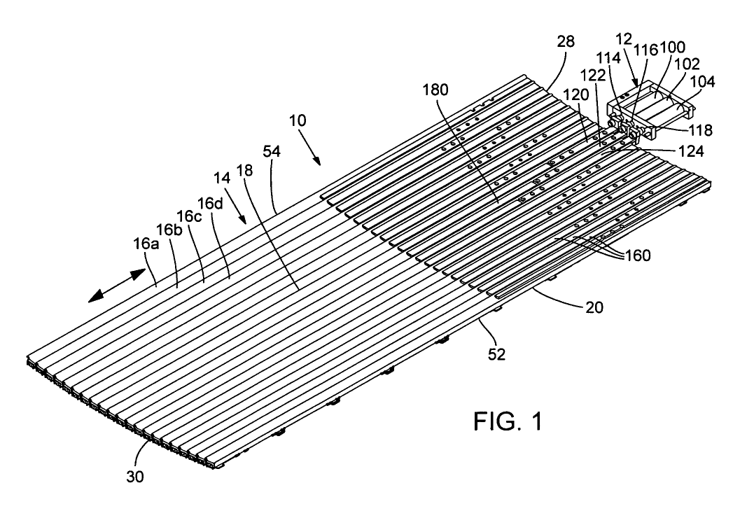

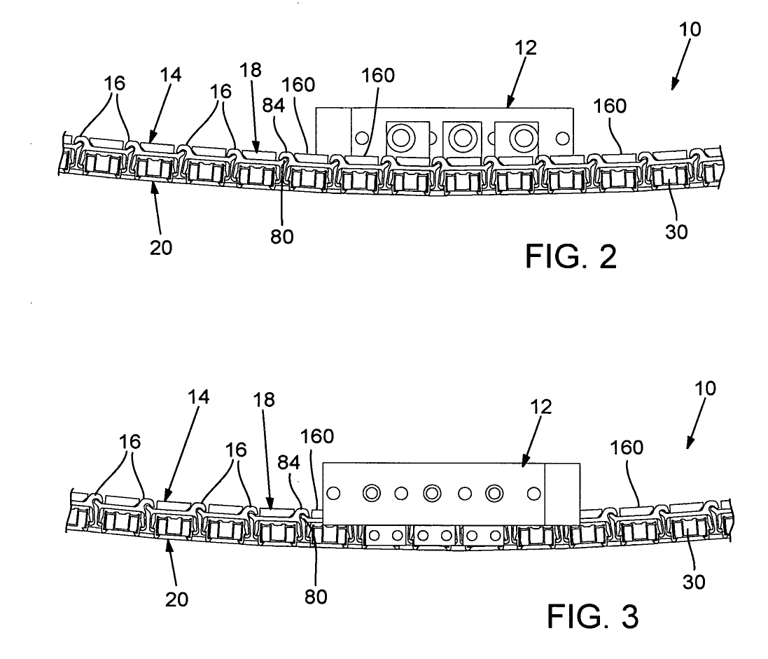

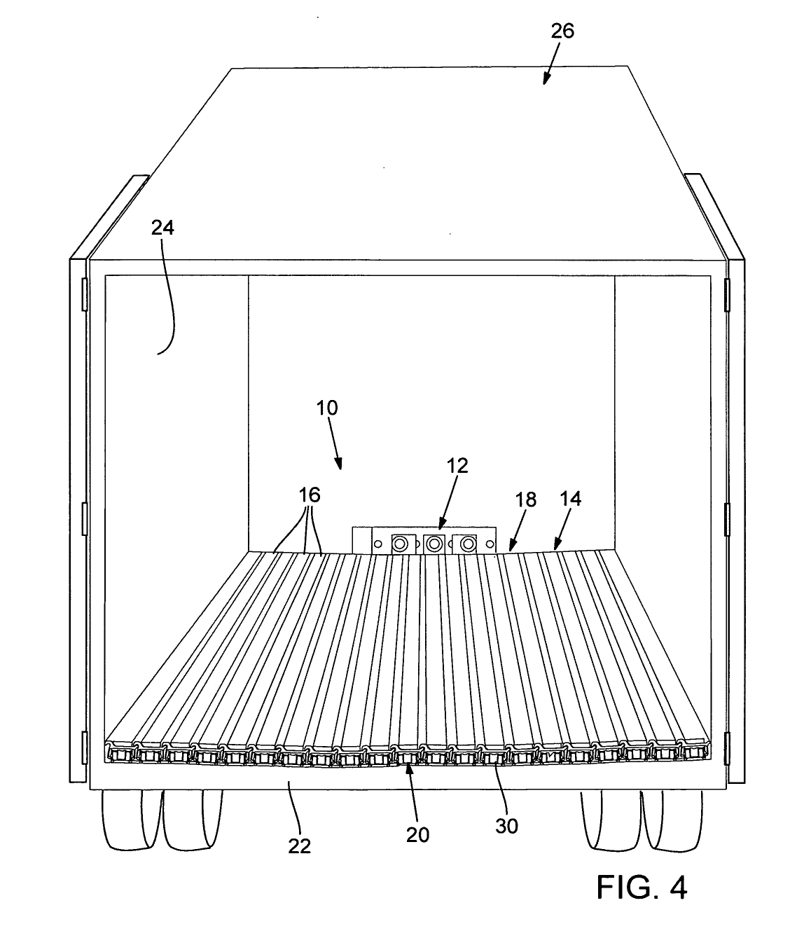

According to one exemplary embodiment, a reciprocating slat conveyor 10 that can be used with containers, such as the container of a garbage collection truck or other vehicles used to transport a load, is shown in FIG. 1. The conveyor is adapted for use with a container having an arcuate floor, although it also can be installed in a container having a flat floor. The conveyor 10 includes a drive mechanism 12 coupled to a reciprocating floor assembly 14 having a plurality of elongated, load-supporting slats 16. The reciprocating slat conveyor 10 desirably has an arcuate or curved cross-sectional shape as best shown in FIGS. 2 and 3. The conveyor 10 includes an upper surface 18 and a lower surface 20. The upper surface 18 provides a concave surface on which cargo, such as refuse, food, grains, recyclables, or other particulate materials, is supported. The lower convex surface 20 rests upon and is coupled to an arcuate support surface or floor, such as floor 22, of a container, such as refuse containment area 24 of a garbage collection truck 26 (see FIG. 4).

The floor assembly 14 is arcuate or curved about an axis located above the upper surface 18 and extending parallel to the longitudinal or lengthwise direction of the floor assembly. The longitudinal or lengthwise direction can be defined as a direction extending from a front end 28 of the assembly 14 to the back end 30 of the assembly along any one of the elongated slats 16 as shown in FIG. 1. The floor assembly 14 in the illustrated embodiment follows the curvature or contour of the support floor 22. More specifically, the upper and lower surfaces 18, 20 can have a radius of curvature approximately equal to the radius of curvature of the support floor 22. In this manner, the curvature of the surface 18 of the floor assembly 14 on which the cargo is supported mimics the curvature of the material support floor 22 of the container 24. Accordingly, the illustrated arcuate floor assembly 14 provides the benefits and advantages of a reciprocating floor, as well as the benefits and advantages of a container with an arcuate floor. In other embodiments, the radius of curvature of the floor assembly can deviate from the radius of curvature of floor on which the floor assembly is mounted. When installed on a flat floor, the floor assembly can be laid flat on the floor to provide a flat upper surface.

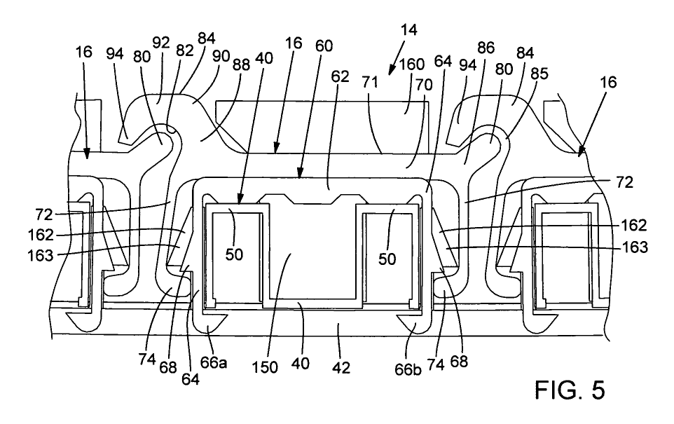

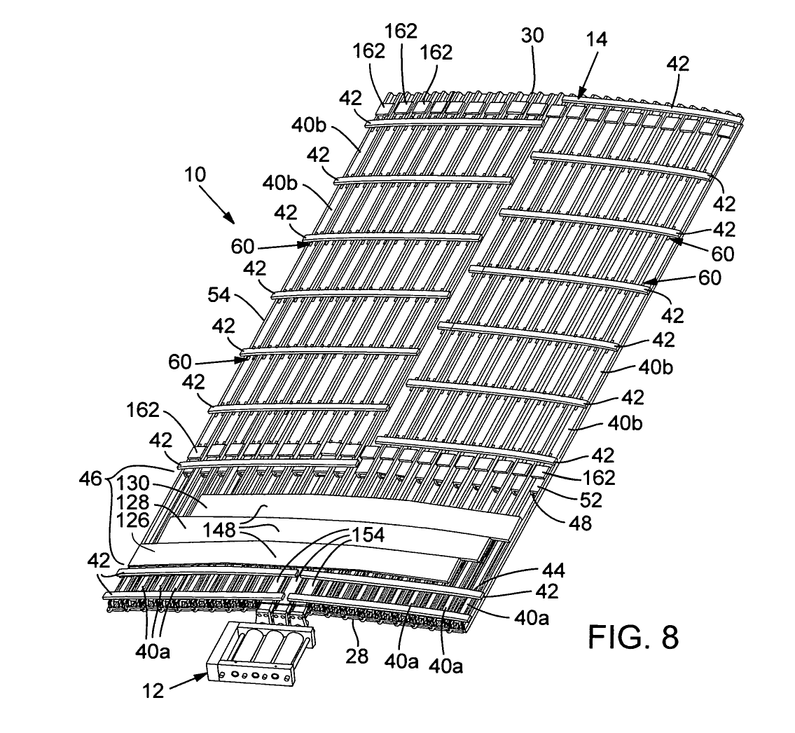

Referring to FIGS. 5-7, the floor assembly 14 can include elongated slat guide beams 40 secured to a plurality of rigid straps 42. As best shown in FIG. 8, the slat guide beams can comprise a first set of guide beams 40a extending from the front end 28 of the floor assembly 14 to a forward end 44 of a cross-drive reciprocation zone 46, and a second set of guide beams 40b extending from the back end 30 of the floor assembly to a rearward end 48 of the drive reciprocation zone. The elongated slat guide beams 40 each have a generally M-shaped cross-sectional shape. The slat guide beams 40 are each secured to the rigid straps 42 (e.g., by bolts, rivets, welding, or other suitable coupling technique) and have two upper ridge portions 50.

As best shown in FIG. 8, the straps 42 extend transversely across the bottom of the floor assembly 14 in a lateral direction perpendicular to the longitudinal direction. The straps 42 can be spaced apart in the longitudinal direction with each strap 42 extending transversely from either a left side 52 or right side 54 to a location proximate the middle of the floor assembly 14. At least some of the straps 42 on the left half of the floor assembly can be staggered longitudinally along the floor assembly 14 relative to straps on the right half of the floor assembly. In some embodiments, the reciprocating slat conveyor 10 is a modular unit and the straps 42 are curved to define the overall curvature of the floor assembly. The straps 42 desirably are secured to the curved floor of a container to provide a base for the floor assembly 14.

Referring to FIGS. 5-8, the floor assembly 14 can also include a plurality of bearings 60 mounted on the slat guide beams 40. As best shown in FIG. 5, each bearing 60 has a generally inverted U-shaped cross-sectional shape with a top wall 62 and two spaced-apart laterally resilient side walls 64 extending transversely away from the top wall. The side walls 64 can be formed with pairs of opposing downwardly and inwardly extending lugs 66a and 66b. Lugs 66a are longitudinally spaced from an adjacent pair of lugs 66b a distance slightly greater than a width of the straps 42. The lateral spacing between each pair of opposing lugs 66a and each pair of opposing lugs 66b is slightly less than a width of a guide beam 40. Each bearing 60 can also include longitudinally extending ribs 68 along the outer surfaces of the side walls 64. The ribs 68 extend laterally outward away from the side walls 64 and can have, in some embodiments, a generally triangular cross-sectional shape as shown in FIG. 5.

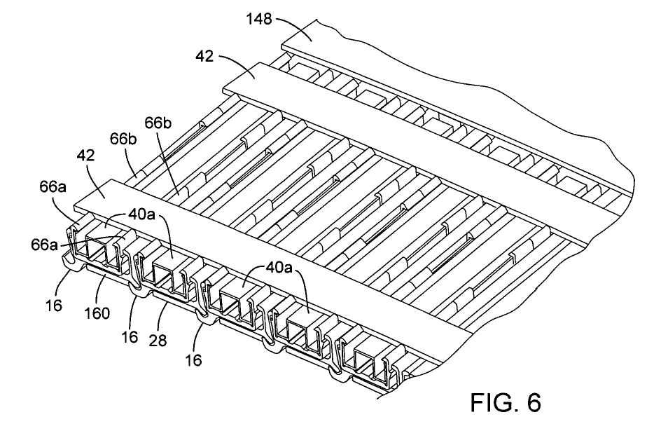

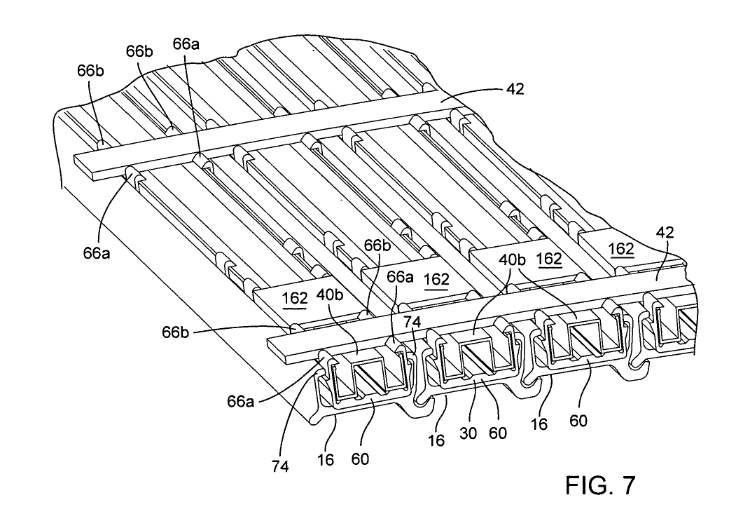

When assembling the floor assembly, each bearing 60 can be pressed down on a guide beam 40 such that a strap 42 extends between lugs 66a and an adjacent pair of lugs 66b (best shown in FIGS. 6 and 7) and the beam causes the side walls 64 to resiliently flex outwardly. Once the lugs 66a, 66b clear the bottom side of the guide beam 40, the lugs snap inwardly under the guide beam such that the strap 42 secures the bearing 60 against longitudinal movement relative to the floor assembly and the guide beam 40 secures the bearing against lateral and vertical movement relative to the floor assembly.

As best shown in FIGS. 8, the floor assembly 14 in the illustrated embodiment includes a bearing 60 at the intersection of each guide beam 40b and a respective strap 42, and a bearing 60 at the intersection of each guide beam 40a and the pair of straps 42 proximate the front end 28. However, the number of bearings and their placement can vary in other embodiments.

The bearings can be made from any of various suitable materials. In certain embodiments, the bearings 60 are made from a synthetic thermoplastic resin, such as polyethylene, or other suitable material having a low coefficient of friction.

Again referring to FIGS. 5-7, each slat 16 in the illustrated configuration comprises an elongated beam-type element having a generally inverted “U” cross-sectional shape. As best shown in FIG. 5, each slat 16 includes a top wall 70 and laterally positioned spaced-apart side walls 72 extending transversely downwardly from the top wall 70 and parallel to each other. The top wall 70 defines an upper material support surface 71. The support surfaces 71 of the series of slats 16 cooperatively define the upper surface 18 of the floor assembly 14. The distal end portions of the side walls 72 include spaced-apart bearing flanges 74 that extend inwardly toward each other. The space between the flanges 74 defines an elongated opening along the length of the slat 16. The distance between the flanges 74 is slightly greater than a distance between the side walls 64 of the bearing 60 and slightly less than a distance between the outer edges of ribs 68.

The slat 16 is mounted over the bearing 60 by inserting the top wall 62 of the bearing into the opening between flanges 74 and pressing the slat downward until the flanges 74 contact the ribs 68. The flanges 74 cause the ribs 68 and the side walls 72 to resiliently deform as the flanges 74 move across the ribs. Once the flanges 74 move beyond the ribs 68, the ribs 68 and side walls 72 recover their original shape to secure the slat 16 against the bearing 60 and resist upward movement of the slat relative to the bearing. In this manner, the slat 16 is allowed to move longitudinally along the bearing 60 but is restricted from vertical and lateral movement relative to the bearing.

Each slat 16 in the illustrated configuration is configured to cooperatively form with an adjacent slat a unique tongue-in-groove, or overlapping, arrangement to minimize or prevent loss of particulate material between the slats. In other words, the cooperative engagement between adjacent slats provides a sealing effect without the need for a seal. Eliminating the need for a seal can provide cost savings as seals and the installation of such seals can be expensive. Further, without seals, the frequent maintenance and replacement associated with seals is eliminated. Of course, seals can be used if desired.

As best shown in FIG. 5, the tongue-in-groove arrangement in the illustrated embodiment includes a tongue 80 of one slat 16 positioned within a groove 82 defined by a hook 84 of an adjacent slat. Each slat 16 can include a tongue 80 extending diagonally outwardly from a first longitudinal corner 86 and a hook 84 extending outwardly from a second longitudinal corner 88 opposite the first corner. Both the tongue 80 and groove 82 of each slat 16 desirably extends the length of the slat. Each corner 86, 88 is defined as the general area of the intersection of a respective longitudinal side wall 72 and the top wall 70. As shown in the rear end view of the floor assembly 14 in FIG. 5, the first corner 86 is a right corner of a tongue-in-groove arrangement and the second corner 88 is a left corner of the tongue-in-groove arrangement.

The tongue-in-groove arrangement is similar to that shown and described in U.S. Pat. No. 6,651,806, which is incorporated herein by reference, but desirably includes several differences in view of the arcuate nature of the floor assembly 14. For example, rather than extending substantially perpendicularly relative to the top wall, the tongue 80 of slat 16 can extend diagonally relative to the top wall 70, for example, at about a 45-degree angle relative to the top wall 70 as shown in FIG. 5. Further, the groove 82 can be diagonally oriented (e.g., at about a 45-degree angle relative to top wall 70) to matingly receive the tongue 80. More specifically, the hook 84 includes a side portion 90 that extends upwardly and outwardly from the corner 88, an upper portion 92 that extends horizontally and outwardly from the side portion 90, and a side portion 94 that extends downwardly and outwardly from the upper portion 92. The side portions 90, 94 and the upper portion 92 define the groove 82 therebetween. Accordingly, the groove 82 is generally downwardly and outwardly directed to receive the diagonal tongue 80 of an adjacent slat 16.

Desirably, when engaged with an adjacent slat, the tongue 80 is positioned within the groove 82, but not in contact with the hook 84. In other words, the tongue 80 desirably is spaced apart from the hook 84 such that no frictional abrasion occurs between the groove and the hook. The space between the tongue 80 and hook 84 defines an unrestricted channel 85 extending upwardly from the support surface 71 and downwardly around the tongue. Because the channel 85 extends upwardly, upward migration and escape of particulate material form the support surface 71 is minimized. Accordingly, the tongue and hook configuration avoids or minimizes particulate materials from falling between adjacent slats 16 without the use of a seal. The configuration of the tongue 80 relative to the groove 82 in the illustrated embodiment allows the orientation of one slat 16 to be positioned in a different orientation about the central axis relative to the orientation of an adjacent slat to form the concave upper surface of the floor assembly without the tongue 80 contacting the hook 84.

As shown in FIG. 1, the left and right sides of the floor assembly 14 are upwardly curved from a center slat 180 that is in alignment with push rod 122 (as will be described in more detail below). Accordingly, materials, especially liquids, tend to funnel downwardly along the curved portions of the floor assembly 14 and accumulate proximate the center slat 180. In certain embodiments, the slats 16 are configured such that the hook 84 of each slat extends inwardly toward the center slat. In this manner, materials, including liquids, moving toward the center slat 16 would travel from the upper surfaces 71 over the top of the hooks 84 and onto an upper surface of an adjacent slat (in a manner similar to water flowing over the shingles of a roof). Because of the downward slope of the upper surfaces 71 of the slats 16, gravity tends to keep the materials from traveling upwardly over the tongues and into the space between the tongue 80 and hook 82, which would result in the materials accumulating between the slats.

The slats 16 of both the right and left sides of the floor assembly 14 shown in the embodiment of FIGS. 2 and 3 are oriented in the same manner, i.e., each slat 16 is arranged in a hook-to-tongue orientation extending laterally across the floor from the right side 54 to the left side 52. In other embodiments, the slats 16 forming the right half of the floor assembly between the ride side 54 and the center slat 180 can be a mirror image of the slats forming the left half of the floor assembly between the left side 52 and the center slat 180. For example, the slats forming the left half can be arranged in a hook-to-tongue orientation extending from the left side 52 to the right side 54 as shown, and the slats forming the right half can be arranged in a hook-to-tongue orientation extending from the right side to the left side. In this manner, materials traveling or flowing down the left and right sides would travel over the hooks onto an adjacent upper surface 71 rather than traveling over the tongues and between the tongue and hooks. In these embodiments, the hook of the center slat 180 can be replaced by a tongue such that the center slat has two diagonally extending tongues for engaging the hooks of the adjacent slats.

In the illustrated embodiment, each slat 16 extends in the longitudinal direction from a front of the container to a rear of the container and is supported above a respective guide beam 40a of the first set of guide beams and a respective guide beam 40b of the second set of guide beams. For example, if the container is the garbage collection area of a garbage truck, the slats 16 can extend substantially the full length of the area. Each slat 16 is capable of low-resistance movement along an associated bearing 60 relative to one or more adjacent slats. The slats 16 in the illustrated embodiment can move relative to each other, but are not in contact with each other.

The reciprocating movement of the slats 16 is facilitated by the drive mechanism 12. Referring to FIG. 9, the drive mechanism 12 includes a plurality of hydraulic cylinders, such as three hydraulic cylinders 100, 102, 104 mounted to and between front and rear panels 106, 108, respectively. The panels 106, 108 are secured to each other by elongated bolts 110 and are secured to and extend transversely from a side panel 112. Each of the hydraulic cylinders 100, 102, 104 includes a respective piston rod 114, 116, 118 extendable and retractable in a direction parallel to the longitudinal direction by a respective one of the cylinders. The hydraulic cylinders and piston rods desirably are positioned at the same level as the floor assembly or at least partially above or above the floor assembly 114 as shown in FIGS. 2 and 3. As shown in FIG. 9, each piston rod 114, 116, 118 can be fixedly coupled to a respective push rod 120, 122, 124 that desirably extends parallel to and is longitudinally aligned with a corresponding one of the piston rods. As used herein, the term “fixedly coupled” means that the coupling between a piston rod and a corresponding push rod does not allow for relative movement between the piston rod and the push rod, such as pivoting movement between these components.

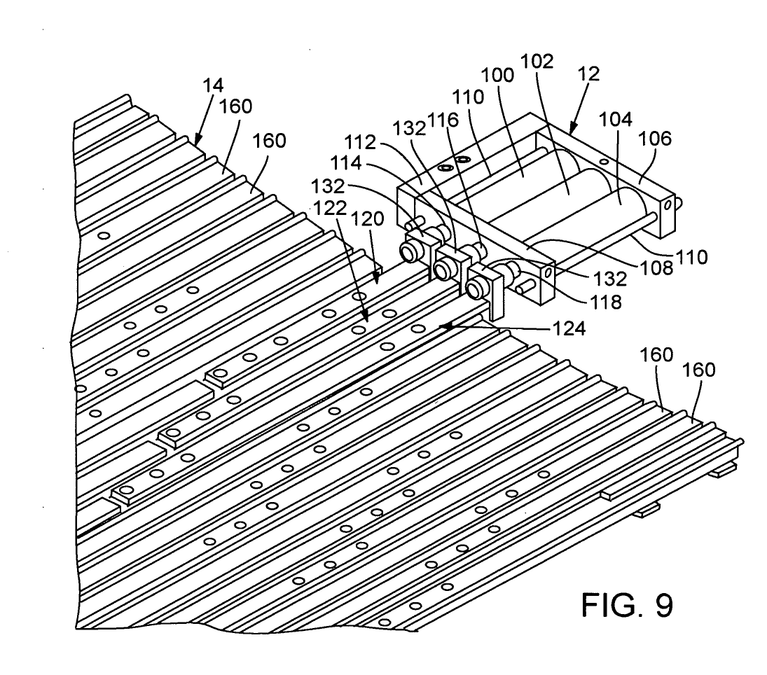

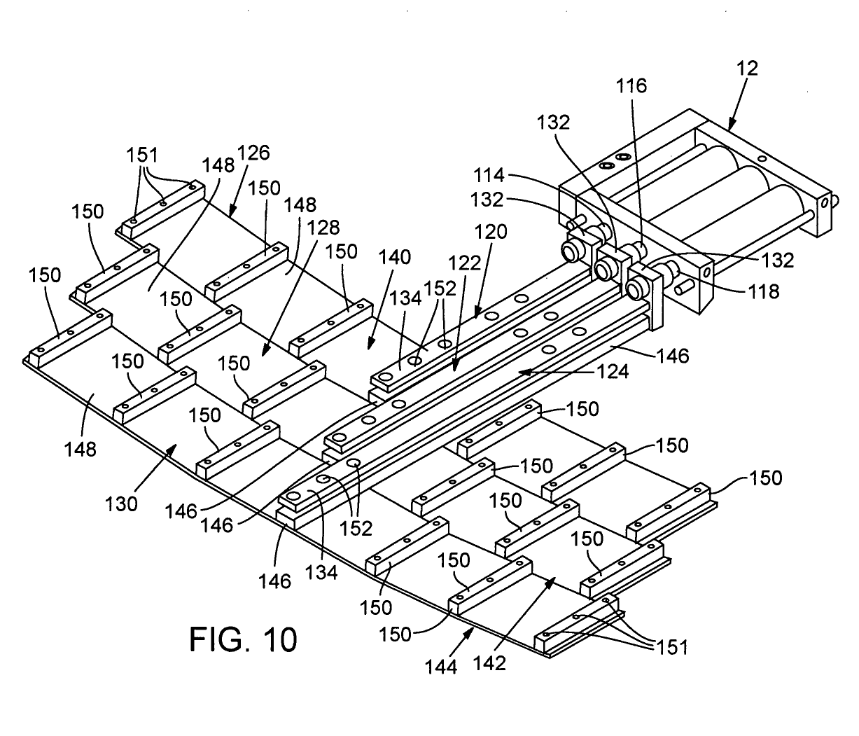

Generally, each push rod 120, 122, 124 is fixedly coupled to a respective cross-drive assembly 126, 128, 130 (FIG. 10) to independently drive the cross-drive assemblies relative to each other. Referring to FIG. 10, the push rods 120, 122, 124 each include a vertical portion 132 and arm 134 extending transversely from the vertical portion in the longitudinal direction. Each arm 134 of the respective push rods 120, 122, 124 has a different length. For example, the arm 134 of push rod 120 has a first length, the arm 134 of push rod 122 has a second length longer than the first length, and the arm 134 of push rod 124 has a third length longer than the second length. The lengths vary approximately by the widths of the cross-drives 140, 142, 144 as will be described in more detail below.

Each push rod can further include an elongated lower connector arm 146 coupled to the vertical portion 132 at a first end portion and coupled to a respective one of the cross-drives 140, 142, 144 at a second end portion (see FIG. 10). The connector arms 146 can also be coupled to and spaced apart from a respective arm 134 at a location beneath the arm to receive a slat 16 (not shown in FIG. 10) therebetween. Like the arms 134, the connector arms 146 extend in the longitudinal direction. The cross-drives 140, 142, 144 include curved panels 148 that extend transversely away from respective connector arms 146. The curved panels 148 desirably have a length approximately equal to a width of the floor assembly 14. Each panel 148 can include a plurality of slat mounts 150 spaced apart along the length of the panels 148. The slat mounts 150 of each panel 148 desirably are spaced apart from each other a distance equal to approximately three times the width of the slats 16. As shown in FIG. 10, the panels 148 are supported at the same level in the floor assembly so that their upper surfaces collectively define a concave surface. In this manner, the slats can be supported on the panels to form the concave upper surface of the floor assembly.

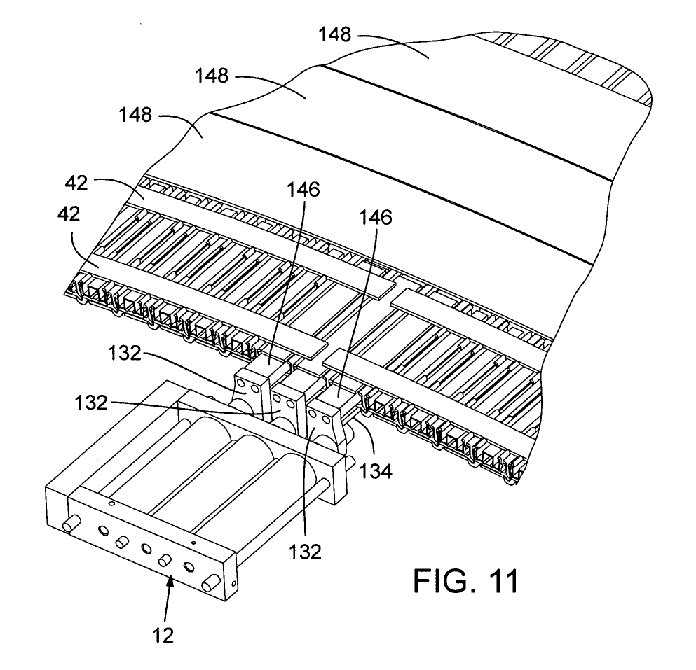

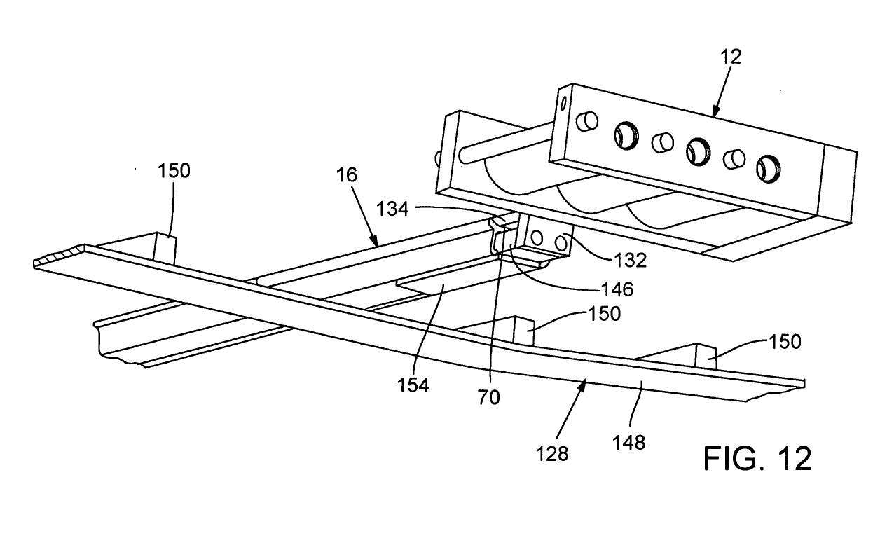

The slats 16 are secured to the cross-drive assemblies 126, 128, 130 such that movement of the cross-drive assemblies 126, 128, 130 correspondingly moves the slats. Each slat 16 can be secured to one of the cross-drive assemblies 126, 128, 130 via a slat mount 150 or one of the elongated connector arms 146. For example, referring to FIG. 12, three slats 16 (with one of the slats being shown) are each secured directly to a respective push rod arm 134 and a respective connector arm 146 by positioning the top wall 70 of each slat in the space between the push rod arm 134 and the corresponding connector arm 146. Fasteners (not shown) are inserted through apertures, such as apertures 152, formed in the arms 134, 146 and each of the three slats 16 (see FIG. 10). In certain implementations, longitudinally extending support bars 154 can be secured to the support straps 42 extending across the guide beams 40a to prevent downward deflection of the connector arms 146 (see FIGS. 11 and 12). In certain implementations, the support bars 154 are made of a material different than that of the connector arms 146 to reduce friction between the connector arms and the support bars. The elongated connector arms 146 are positioned above and slide along a respective support bar 154.

Accordingly, the cross-drive assemblies in the illustrated embodiment are coupled to the piston rods via a respective push rod that is directly and fixedly coupled to, and maintained in longitudinal and parallel alignment with, the piston rods. In this manner, the cross-drive assemblies are coupled to the piston rods without pivoting connections such that the cross-drive assemblies remain in longitudinal and parallel alignment with the piston rods. Moreover, the cross-drive assemblies are coupled to the push rods at a location proximate, e.g., adjacent, the piston rods. The slats in the illustrated embodiment are directly and fixedly coupled to the cross-drive assemblies, and therefore remain in longitudinal and parallel alignment with the piston rods. Maintaining the slats in longitudinal and parallel alignment in this manner helps to prevent lateral movement and buckling of the slats, damage to the container, and mechanical breakdown of the piston rods and associated components.

Further, as best shown in FIG. 12, the cross-drives are longitudinally spaced from the piston rods and each connector arm 146 extends into the floor assembly but does not extend above the upper surface 18 or below the lower surface 20 of the floor assembly. Each upper arm 134 extends along the upper surface of a respective slat 16. This manner of coupling the piston rods to the cross-drives minimizes the overall height, or cross-sectional profile, of the floor assembly.

The remaining slats 16 are secured to one of the slat mounts 150 by extending fasteners through apertures, such as apertures 151, formed in the slats and mounts (FIG. 10). In some embodiments, the floor assembly 14 includes a plurality of wear plates 160 each associated with one of the remaining slats 16 (see FIGS. 1, 5 and 9). Each wear plate 160 can be secured to the support surface 71 of a respective slat 16 between the tongue 80 and hook 84 by extending fasteners through apertures formed in the wear plate and the apertures in the slats and mounts. In certain embodiments, the wear plates 160 can also be welded to the support surface 71 at ends of the wear plates. The wear plates 160 are provided to alleviate wear on the slats 16. When used in garbage trucks, most wear occurs in the area between the forward end 28 and the midpoint between the forward end and the rear end 30. Thus, as shown in FIG. 1, the wear plates 160 extend from the forward end 28 half way along the length of the floor assembly. In other embodiments, the wear plates 160 can extend the entire length of the slats or they can extend along selected portions of the slats.

The illustrated embodiment includes three piston rods, three push rods, three cross-drive assemblies, and three sets of slats. In other embodiments, the floor assembly can include a greater or fewer number of piston rods and associated push rods, cross-drive assemblies, and sets of slats.

As shown in FIG. 8, the floor assembly 14 can include a plurality of hold down bearings 162 positioned proximate the back end 30 of the floor assembly and the rearward end 48 of the drive reciprocating zone 46. The hold down bearings 162 have a generally U-shaped cross-sectional shape with inwardly extending lateral barbs 163 configured to engage the flanges 74 of the slats 16 (see FIG. 5). The bearings 162 are positioned beneath the guide beams 40 with side portions that form the barbs 163 extending upwardly beyond the flanges 74. Similar to the ribs 68 of the bearings 60, the barbs 163 of the hold down bearings 162 provide additional resistance to upward movement of, e.g., separation of, the slats 16 relative to the bearings 60.

Although many of the components of the drive mechanism 12 and floor assembly 14 are secured together via fasteners as described above, in some implementations, the components can coupled via welding or other coupling techniques.

The reciprocating slat conveyor 10 operates to convey or move particulate materials on the floor assembly 14 longitudinally in a front-to-rear direction by reciprocating three sets of slats 16 via the drive mechanism 12. Each of the three sets of slats 16 is associated with a respective one of the three cross-drive assemblies 126, 128, 130. More specifically, the slats 16 of the first set of slats are each secured to the cross-drive 140, the slats of the second set of slats are each secured to the cross-drive 142, and the slats of the third set of slats are each secured to the cross-drive 144. Each slat 16 desirably is connected to a different cross-drive assembly than an adjacent slat. In the illustrated embodiment, for example, referring to FIG. 1, the slat 16a adjacent the right side 54 is coupled to the cross-drive assembly 126 and is a member of the first set of slats. The next adjacent slat 16b, or second slat away from the right side 54, is coupled to the cross-drive assembly 128 and is a member of the second set of slats. The next adjacent slat 16c, or third slat away from the right side 54, is coupled to the cross-drive assembly 130 and is a member of the third set of slats. The next adjacent slat 16d, or fourth slat away from the right side 54, is coupled to the cross-drive assembly 128 and is a member of the first set of slats. The remaining slats 16 follow the same pattern laterally across the width of the floor assembly 14.

In operation, the hydraulic cylinders 100, 102, 104 are controlled to extend and retract the piston rods 114, 116, 118, which move the push rods 120, 122, 124 longitudinally toward and away from the back end 30. Movement of the push rods 120, 122, 124 causes the cross-drives 140, 142, 144, respectively, to move longitudinally toward and away from the back end 30. As the cross-drives move, the respective slats 16 secured to the drives also move longitudinally toward and away from the back end 30. The range of motion of the piston rods and the lengths of the arms 134, 146 are predetermined such that the cross-drives move longitudinally within the cross-drive reciprocation zone 46 (FIG. 8).

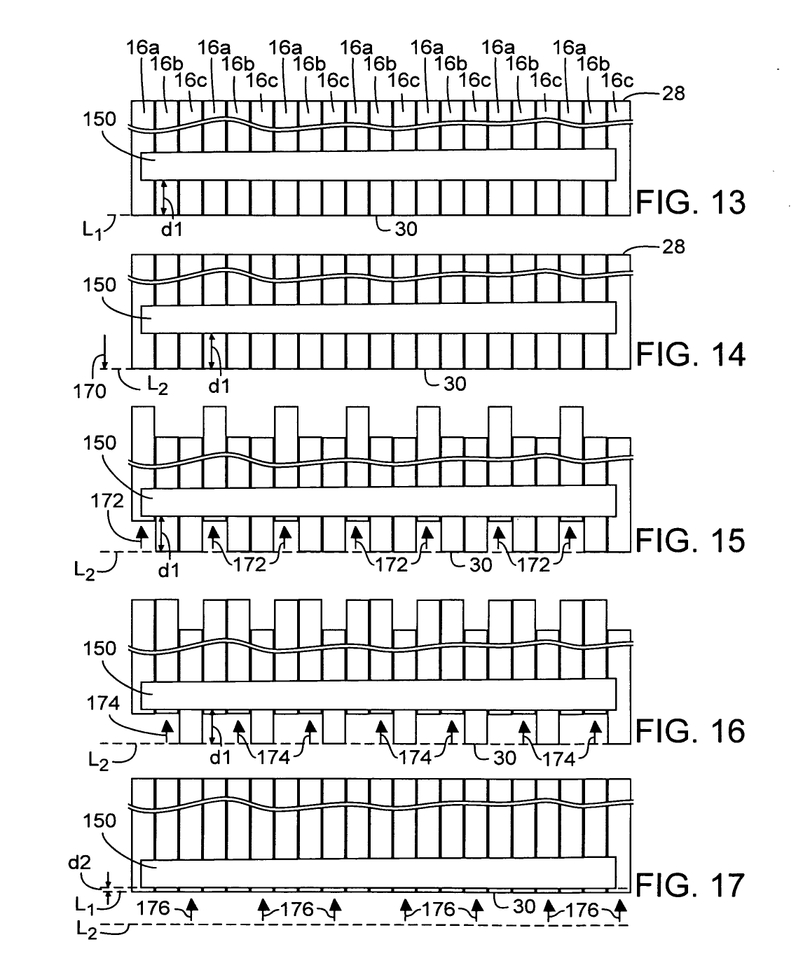

Referring to FIGS. 13-17, the cooperative movement of the slats 16 of the floor assembly 14 convey an object 150 in a direction from the front end to the rear end of the floor assembly to be exited from a container. In FIG. 13, the object 150 is at a distance d1 from the rear end of the slats, which is represented by line L₁. In FIG. 14, the slats 16a, 16b, 16c simultaneously move rearwardly as indicated by arrow 170 by a unified extension of the hydraulic cylinders 100, 102, 104. Because all the slats are moved, the object 150 moves longitudinally along with the slats in the rearward direction. The new location of the end 30 of the slats is shown by line L₂ in FIG. 14. In FIG. 15, the hydraulic cylinder 100 is activated to retract a first set of slats 16a coupled to cross-drive assembly 126 in the direction indicated by arrows 172. The object 150 remains a distance d1 away from the back end 30 (defined by the rearward-most slats) during the retraction of the slats 16a. In FIG. 16, the hydraulic cylinder 102 is activated to retract a second set of slats 16b coupled to cross-drive assembly 128 in the direction indicated by arrows 174. The object 150 remains a distance d1 away from the back end 30 during the retraction of the slats 16b. In FIG. 17, the hydraulic cylinder 104 is activated to retract a third set of slats 16c coupled to cross-drive assembly 130 in the direction indicated. The object 150 now is at a distance d2 away from the back end 30, represented by L₁ in FIG. 17. The hydraulic cylinders 100, 102, 104 are then activated to simultaneously extend the three sets of slats 16a, 16b, 16c in a longitudinally rearward direction. The retraction process is repeated until the object 150 falls off the rear end 30 of the floor assembly 14.

The circuitry associated with the operations described above can have any of various designs. For example, according to one embodiment, the hydraulic circuitry for reciprocating the slats on a predetermined sequence of movements is described in U.S. Pat. No. 6,513,648, which is incorporated herein by reference.

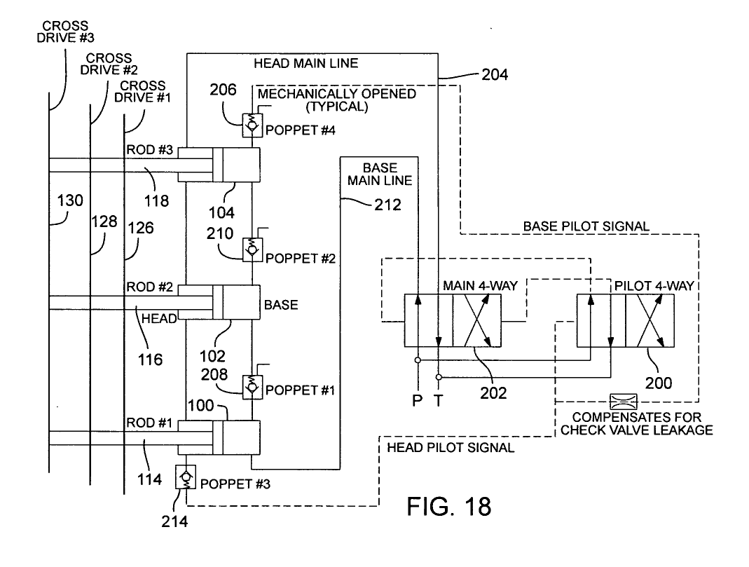

FIG. 18 illustrates another hydraulic circuit that can be implemented in the embodiments of the conveyor described herein. The hydraulic circuit shown in FIG. 18 includes a pilot four-way valve 200 and a main four-way valve 202 fluidly connected to the hydraulic cylinders 100, 102, and 104. At the beginning of an operating cycle, oil flows to the cylinders via a head line 204 to retract piston rods 114, 116, 118 according to the cycle described above. A check valve 206 prevents the pilot valve 200 from shifting at this time. The first piston rod 114 retracts first while movement of piston rods 116, 118 is restricted by check valves 208, 210, respectively; the second piston rod 116 retracts when check valve 208 is opened by movement of the first piston rod; and the third piston rod 118 retracts when check valve 210 is opened by movement of the second piston rod 116. Retraction of the third piston rod 118 causes check valve 206 to open, allowing the pilot valve 200 to shift, which in turn shifts the main valve 202, allowing oil to flow to the cylinders via the base line 212. Oil from the base line pressurizes the cylinders, causing the piston rods to extend simultaneously. Extension of the first piston 114 causes a check valve 214 to open, relieving the head pilot signal line and allowing the pilot valve 200 to shift. This in turn causes the main valve 202 to shift, allowing oil to return to the head line 204 to begin retracting the piston rods.

In view of the many possible embodiments to which the principles of the disclosed conveyor may be applied, it should be recognized that the illustrated embodiments are only preferred examples and should not be taken as limiting the scope of the invention.

For example, in alternative embodiments, the slats can be connected to respective cross-drives at a location below the panels 148 of the cross-drives. The cross-drives can be connected to respective push rods and connector arms, which in turn can be coupled to respective piston rods as described above to effect reciprocating movement of the cross-drives and the slats.

We claim:

1. A reciprocating slat conveyor comprising:
a floor assembly defining an upper surface and a bottom surface and comprising a plurality of elongated, load-supporting slats operable to reciprocate longitudinally of the floor assembly,
wherein the upper surface of the floor assembly comprises a concave surface that is curved about an axis located above and extending longitudinally of the floor assembly.

2. The conveyor of claim 1, further comprising:
a drive mechanism comprising at least first and second reciprocating piston rods;
at least first and second push rods fixedly coupled and extending parallel to the first and second piston rods, respectively, the first and second push rods being connected to first and second cross-drives, respectively, of the floor assembly;
wherein the slats comprise a first set of slats connected to the first cross-drive and a second set of slats connected to the second cross-drive such that reciprocating movement of the first piston rod causes corresponding movement of the first set of slats and reciprocating movement of the second piston rod causes corresponding movement of the second set of slats.

3. The conveyor of claim 2, wherein:
the at least first and second piston rods comprise at least first, second, and third piston rods;
the at least first and second push rods comprise at least first, second, and third push rods fixedly coupled and extending parallel to the first, second, and third piston rods, respectively, the first, second, and third push rods being connected to first, second, and third cross-drives, respectively, of the floor assembly;
wherein the slats comprise a third set of slats connected to the third cross-drive such that reciprocating movement of the third piston causes corresponding movement of the third set of slats.

4. The conveyor of claim 2, wherein the first and second cross-drives each comprises a laterally extending curved panel, the first set of slats being mounted on the panel of the first cross-drive and the second set of slats being mounted on the panel of the second cross-drive, the panels having concave curved upper surfaces that are supported at the same level in the floor assembly.

5. The conveyor of claim 3, wherein the first, second, and third cross-drives each comprises a laterally extending curved panel, the panels having concave curved upper surfaces that are supported at the same level in the floor assembly, the first, second, and third sets of slats being mounted on the upper surfaces of the panels of the first, second, and third cross-drives, respectively.

6. The conveyor of claim 5, wherein the second cross-drive is positioned forwardly of and next to the first cross-drive, and the third cross-drive is positioned forwardly of and next to the second cross-drive.

7. The conveyor of claim 3, wherein the first, second, and third piston rods are longitudinally aligned with the first, second, and third push rods, respectively, along the length of the floor assembly.

8. The conveyor of claim 1, wherein each slat has an upper surface and opposing longitudinal corners on either side of the upper surface, a tongue extending outwardly from one longitudinal corner and a hook portion extending outwardly from the other longitudinal corner and defining a groove, the tongue being received in the groove of a hook portion of an adjacent slat.

9. The conveyor of claim 8, wherein the tongue of each slat extends at about a 45-degree angle with respect to the upper surface of the corresponding slat.

10. The conveyor of claim 8, wherein the tongue of each slat extends into but does not contact the hook portion of an adjacent slat.

11. A container assembly for a vehicle, the assembly comprising:
a container for containing a load, the container having a forward end and a rear end defining a container opening, the container having a floor; and
a conveyor supported on the floor of the container, the conveyor comprising a floor assembly defining an upper surface, a bottom surface, a forward end, and a rear end proximate the container opening, the floor assembly comprising a plurality of elongated, load-supporting slats operable to reciprocate longitudinally of the floor assembly, wherein the upper surface of the floor assembly comprises a concave surface that is curved about an axis located above and extending longitudinally of the floor assembly.

12. The assembly of claim 11, wherein the floor of the container comprises a concave surface that is curved about an axis located above and extending longitudinally of the floor.

13. The assembly of claim 11, wherein the conveyor comprises a hydraulic drive mechanism located adjacent the forward end of the floor assembly, the drive mechanism comprising a plurality of reciprocating piston rods being configured to effect reciprocation of the slats.

14. The assembly of claim 13, wherein the floor assembly comprises a plurality of cross-drives extending laterally of the floor assembly, each cross-drive being connected to respective slats of said plurality of slats, the conveyor further comprising a plurality of push rods each having a forward end portion fixedly secured to one of said piston rods and a rear end portion connected to one of said cross-drives, each push rod being longitudinally aligned with a corresponding piston rod, wherein reciprocating motion of each piston rod is effective to cause corresponding motion of a corresponding push rod, a corresponding cross-drive, and corresponding slats.

15. The assembly of claim 14, wherein the plurality of piston rods comprises at least first, second, and third piston rods, the plurality of push rods comprises at least first, second, and third push rods connected to the first, second, and third piston rods, respectively, and the plurality of cross-drives comprises at least first, second, and third cross-drives connected to the first, second, and third push rods, respectively, wherein the second cross-drive is positioned forwardly of the first cross-drive and the second push rod is longer than the first push rod, and the third cross-drive is positioned forwardly of the second cross-drive and the third push rod is longer than the second push rod.

16. The assembly of claim 15, wherein each cross-drive comprises a laterally extending panel having a concave upper surface on which corresponding slats are mounted, each panel upper surface being supported at the same level in the floor assembly.

17. The assembly of claim 13, wherein the piston rods are located above the upper surface of the floor assembly.

18. The assembly of claim 11, wherein each slat has an upper surface and opposing longitudinal corners on either side of the upper surface, a tongue extending outwardly from one longitudinal corner at about a 45-degree angle relative to the slat upper surface and a hook portion extending cutwardly from the other longitudinal corner and defining a groove, the tongue being received in the groove of a hook portion of an adjacent slat.

19. The assembly of claim 11, wherein the slats are supported on respective bearings of the floor assembly for reciprocating motion such that each slat can move longitudinally of the floor assembly without contacting an adjacent slat.

20. A reciprocating slat conveyor comprising:
a drive mechanism comprising at least first and second reciprocating piston rods;
at least first and second cross-drives;
at least first and second connector arms having respective forward end portions coupled to the first and second piston rods, respectively, the first and second connector arms also having respective rear end portions connected to the first and second cross-drives, respectively; and
a floor assembly defining an upper surface, a bottom surface and a height between the upper surface and the bottom surface, the floor assembly comprising a plurality of elongated, load-supporting slats operable to reciprocate longitudinally of the floor assembly, the plurality of slats comprising a first set of slats connected to the first cross-drive and a second set of slats connected to the second cross-drive such that reciprocating movement of the first piston rod causes corresponding movement of the first connector arm, the first cross-drive and the first set of slats, and reciprocating movement of the second piston rod causes corresponding movement of the second connector arm, the second cross-drive and the second set of slats;
wherein the rear end portions of the connector arms extend into the floor assembly at or below the upper surface and at or above the lower surface.

21. A reciprocating slat conveyor comprising:
a floor assembly comprising a first, forward set of longitudinally extending guide beams and a second, rear set of longitudinally extending guide beams that are longitudinally spaced from the first set of the guide beams by a cross-drive reciprocating zone, at least first and second cross-drives disposed in the reciprocating zone between the first and second set of guide beams, and a plurality of elongated, load-supporting slats operable to reciprocate longitudinally of the floor assembly, the plurality of slats comprising at least a first and second set of slats, each slat of the first set of slats being supported on respective guide beams of the first and second sets of guide beams and being connected to the first cross-drive, and each slat of the second set of slats being supported on respective guide beams of the first and second sets of guide beams and being connected to the second cross-drive, wherein reciprocating movement of the first cross-drive causes corresponding movement of the first set of slats and reciprocating moving of the second cross-drive causes corresponding movement of the second set of slats; and
a drive mechanism comprising at least first and second reciprocating piston rods positioned forwardly of the first set of guide beams and being coupled to the first and second cross-drives, respectively, to effect reciprocating movement of the cross-drives and the slats.

22. The conveyor of claim 21, further comprising:
at least first and second connector arms having respective forward end portions coupled to the first and second piston rods, respectively, and respective rear end portions connected to the first and second cross-drives, respectively, each connector arm extending from a forward end of the floor assembly into the reciprocating zone.

23. The conveyor of claim 21, wherein a portion of each connector arm extends parallel to and in a side-by-side relationship with an adjacent slat.

24. A container assembly for a vehicle, the assembly comprising:
a container for containing a load, the container having a forward end and a rear end defining a container opening, the container having a liquid-impermeable floor; and
a conveyor supported on the floor of the container, the conveyor comprising a floor assembly defining a forward end and a rear end proximate the container opening, the floor assembly comprising at least first and second cross-drives and a plurality of elongated, load-supporting slats operable to reciprocate longitudinally of the floor assembly, the plurality of slats comprising a first set of slats connected to the first cross-drive at a position above the first cross-drive and a second set of slats connected to the second cross-drive at a position above the second cross-drive, wherein reciprocating movement of the first cross-drive causes corresponding movement of the first set of slats and reciprocating moving of the second cross-drive causes corresponding movement of the second set of slats.

25. A reciprocating slat conveyor comprising:
a floor assembly defining an upper surface, a bottom surface, a forward end, and a rear end, the floor assembly comprising a plurality of elongated, load-supporting slats operable to reciprocate longitudinally of the floor assembly, wherein the upper surface of the floor assembly comprises a concave surface that is curved about an axis located above and extending longitudinally of the floor assembly, the plurality of slats comprising at least a first set of slats, a second set of slats, and a third set of slats;
a hydraulic drive mechanism located adjacent the forward end of the floor assembly, the drive mechanism comprising at least first, second, and third reciprocating piston rods being configured to effect reciprocating motion of the slats;
at least first, second, and third push rods each having a forward end portion and a rear end portion, the first push rod being longitudinally aligned with the first piston rod and fixedly secured at its forward end portion to the first piston rod, the second push rod being longitudinally aligned with the second piston rod and fixedly secured at its forward end portion to the second piston rod, the third push rod being longitudinally aligned with the third piston rod and fixedly secured at its forward end portion to the third piston rod; and
at least first, second, and third laterally extending cross-drives being connected to the first, second, and third sets of slats, respectively, the second cross-drive being positioned forwardly of the first cross-drive and the third cross-drive being positioned forwardly of the second cross-drive, the first push rod being connected at its rear end portion to the first cross-drive, the second push rod being connected at its rear end portion to the second cross-drive and being longer than the first push rod, and the third push rod being connected at its rear end portion to the third cross-drive and being longer than the second push rod, each cross-drive comprising a laterally extending panel having a concave upper surface on which corresponding slats are mounted, each panel upper surface being supported at the same level in the floor assembly;
wherein each slat has an upper surface and opposing longitudinal corners on either side of the upper surface, a tongue extending outwardly from one longitudinal corner at about a 45-degree angle relative to the slat upper surface and a hook portion extending outwardly from the other longitudinal corner and defining a groove, the tongue being received in the groove of a hook portion of an adjacent slat.
